(19) United States
(12) Patent Application Publication
(10) Pub. No.: US 2017/0329332 A1
(43) Pub. Date: Nov. 16, 2017

(54) CONTROL SYSTEM TO ADJUST OPERATION OF AN AUTONOMOUS VEHICLE BASED ON A PROBABILITY OF INTERFERENCE BY A DYNAMIC OBJECT

(71) Applicant: Uber Technologies, Inc., San Francisco, CA (US)

(72) Inventors: Thomas Pilarski, Pittsburgh, PA (US); James Bagnell, Pittsburgh, PA (US); Anthony Stentz, Pittsburgh, PA (US); Peter Rander, Pittsburgh, PA (US); Brett Browning, Pittsburgh, PA (US)

(21) Appl. No.: 15/151,394

(22) Filed: May 10, 2016

(51) Int. Cl. G05D 1/00; B60W 30/14

(52) U.S. Cl. CPC G05D 1/0088; B60W 30/143

(57) ABSTRACT

An autonomous vehicle operates to obtain sensor data for a road segment that is in front of the vehicle. The autonomous vehicle can include a control system which processes the sensor data to determine an interference value that reflects a probability that at least a detected object will interfere with a selected path of the autonomous vehicle at one or more points of the road segment. The control system of the autonomous vehicle can adjust operation of the autonomous vehicle based on the determined interference value.

### TECHNICAL FIELD

Examples described herein relate to autonomous vehicles, and more specifically, to a control system to adjust operation of an autonomous vehicle based on a probability of interference by a dynamic object.

### BACKGROUND

Autonomous vehicles refers to vehicles which replace human drivers with sensors and computer-implemented intelligence, sensors and other automation technology. Under existing technology, autonomous vehicles can readily handle driving with other vehicles on roadways such as highways. However, urban settings can pose challenges to autonomous vehicles, in part because crowded conditions can cause errors in interpretation of sensor information.

### BRIEF DESCRIPTION OF THE DRAWINGS

FIG. 1 illustrates an example of a control system for operating an autonomous vehicle.

FIG. 2 illustrates an example implementation of a prediction engine in context of a control system for the autonomous vehicle.

FIG. 3 illustrates an example method for operating an autonomous vehicle to anticipate events.

FIG. 4 illustrates an example of an autonomous vehicle that can operate predictively to anticipate objects which can interfere or collide with the vehicle.

FIG. 5 is a block diagram that illustrates a control system for an autonomous vehicle upon which embodiments described herein may be implemented.

### DETAILED DESCRIPTION

Examples include a control system for an autonomous vehicle which includes logic to make predictive determinations, and further to perform anticipatory actions in response to predictive determinations. As described with various examples, the predictive determinations can be made with respect to specific classes of objects, and further with respect to use of contextual information about the object, geographic region or locality, and/or surroundings.

According to some examples, an autonomous vehicle operates to obtain sensor data for a road segment that is in front of the vehicle. The autonomous vehicle can include a control system which processes the sensor data to determine an interference value that reflects a probability that at least a detected object will interfere with a selected path of the autonomous vehicle at one or more points of the road segment. The control system of the autonomous vehicle can adjust operation of the autonomous vehicle based on the determined interference value.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Numerous examples are referenced herein in context of an autonomous vehicle. An autonomous vehicle refers to any vehicle which is operated in a state of automation with respect to steering and propulsion. Different levels of autonomy may exist with respect to autonomous vehicles. For example, some vehicles today enable automation in limited scenarios, such as on highways, provided that drivers are present in the vehicle. More advanced autonomous vehicles drive without any human driver inside the vehicle. Such vehicles often are required to make advance determinations regarding how the vehicle is behave given challenging surroundings of the vehicle environment.

System Description

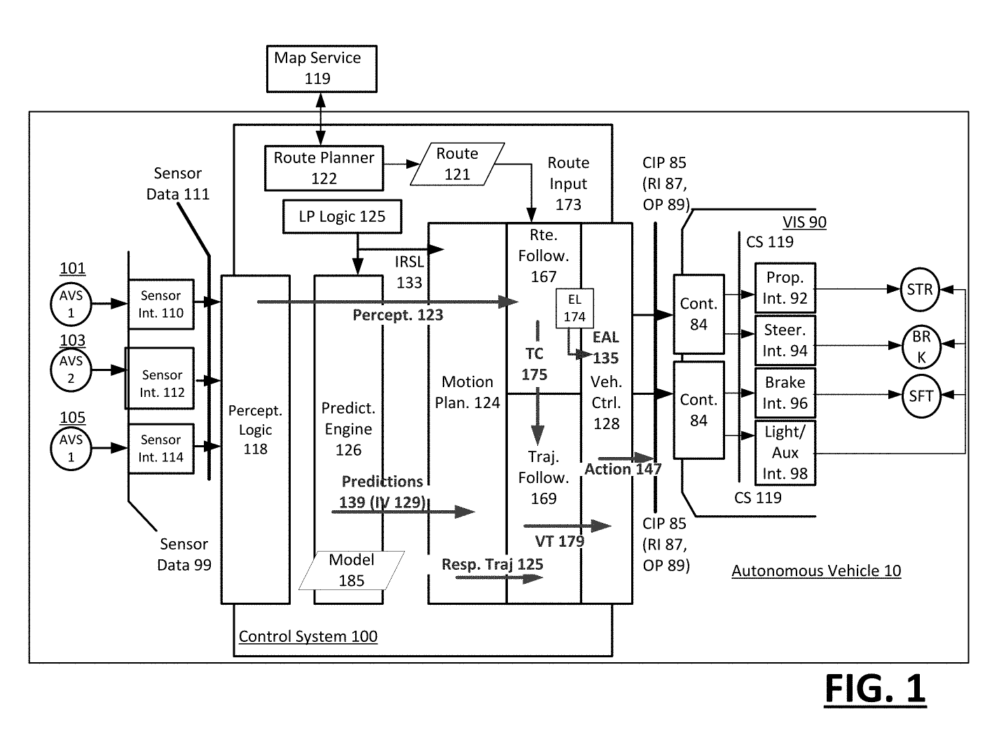

FIG. 1 illustrates an example of a control system for an autonomous vehicle. In an example of FIG. 1, a control system 100 is used to autonomously operate a vehicle 10 in a given geographic region for a variety of purposes, including transport services (e.g., transport of humans, delivery services, etc.). In examples described, an autonomously driven vehicle can operate without human control. For example, in the context of automobiles, an autonomously driven vehicle can steer, accelerate, shift, brake and operate lighting components. Some variations also recognize that an autonomous-capable vehicle can be operated either autonomously or manually.

In one implementation, the control system 100 can utilize specific sensor resources in order to intelligently operate the vehicle 10 in most common driving situations. For example, the control system 100 can operate the vehicle 10 by autonomously steering, accelerating and braking the vehicle 10 as the vehicle progresses to a destination. The control system 100 can perform vehicle control actions (e.g., braking, steering, accelerating) and route planning using sensor information, as well as other inputs (e.g., transmissions from remote or local human operators, network communication from other vehicles, etc.).

In an example of FIG. 1, the control system 100 includes a computer or processing system which operates to process sensor data that is obtained on the vehicle with respect to a road segment that the vehicle is about to drive on. The sensor data can be used to determine actions which are to be performed by the vehicle 10 in order for the vehicle to continue on a route to a destination. In some variations, the control system 100 can include other functionality, such as wireless communication capabilities, to send and/or receive wireless communications with one or more remote sources. In controlling the vehicle, the control system 100 can issue instructions and data, shown as commands 85, which programmatically controls various electromechanical interfaces of the vehicle 10. The commands 85 can serve to control operational aspects of the vehicle 10, including propulsion, braking, steering, and auxiliary behavior (e.g., turning lights on).

Examples recognize that urban driving environments present significant challenges to autonomous vehicles. In particular, the behavior of objects such as pedestrians, bicycles, and other vehicles can vary based on geographic region (e.g., country or city) and locality (e.g., location within a city). Additionally, examples recognize that the behavior of such objects can vary based on various other events, such as time of day, weather, local events (e.g., public event or gathering), season, and proximity of nearby features (e.g., crosswalk, building, traffic signal). Moreover, the manner in which other drivers respond to pedestrians, bicyclists and other vehicles varies by geographic region and locality.

Accordingly, examples provided herein recognize that the effectiveness of autonomous vehicles in urban settings can be limited by the limitations of autonomous vehicles in recognizing and understanding how to process or handle the numerous daily events of a congested environment. In particular, examples described recognize that contextual information can enable autonomous vehicles to understand and predict events, such as the likelihood that an object will collide or interfere with the autonomous vehicle. While in one geographic region, an event associated with an object (e.g., fast moving bicycle) can present a threat or concern for collision, in another geographic region, the same event can be deemed more common and harmless. Accordingly, examples are described which process sensor information to detect objects and determine object type, and further to determine contextual information about the object, the surroundings, and the geographic region, for purpose of making predictive determinations as to the threat or concern which is raised by the presence of the object near the path of the vehicle.

The autonomous vehicle 10 can be equipped with multiple types of sensors 101, 103, 105, which combine to provide a computerized perception of the space and environment surrounding the vehicle 10. Likewise, the control system 100 can operate within the autonomous vehicle 10 to receive sensor data from the collection of sensors 101, 103, 105, and to control various electromechanical interfaces for operating the vehicle on roadways.

In more detail, the sensors 101, 103, 105 operate to collectively obtain a complete sensor view of the vehicle 10, and further to obtain information about what is near the vehicle, as well as what is near or in front of a path of travel for the vehicle. By way of example, the sensors 101, 103, 105 include multiple sets of cameras sensors 101 (video camera, stereoscopic pairs of cameras or depth perception cameras, long range cameras), remote detection sensors 103 such as provided by radar or Lidar, proximity or touch sensors 105, and/or sonar sensors (not shown).

Each of the sensors 101, 103, 105 can communicate with, or utilize a corresponding sensor interface 110, 112, 114. Each of the sensor interfaces 110, 112, 114 can include, for example, hardware and/or other logical component which is coupled or otherwise provided with the respective sensor. For example, the sensors 101, 103, 105 can include a video camera and/or stereoscopic camera set which continually generates image data of an environment of the vehicle 10. As an addition or alternative, the sensor interfaces 110, 112, 114 can include a dedicated processing resource, such as provided with a field programmable gate array (“FPGA”) which receives and/or processes raw image data from the camera sensor.

In some examples, the sensor interfaces 110, 112, 114 can include logic, such as provided with hardware and/or programming, to process sensor data 99 from a respective sensor 101, 103, 105. The processed sensor data 99 can be outputted as sensor data 111. As an addition or variation, the control system 100 can also include logic for processing raw or pre-processed sensor data 99.

According to one implementation, the vehicle interface subsystem 90 can include or control multiple interfaces to control mechanisms of the vehicle 10. The vehicle interface subsystem 90 can include a propulsion interface 92 to electrically (or through programming) control a propulsion component (e.g., a gas pedal), a steering interface 94 for a steering mechanism, a braking interface 96 for a braking component, and lighting/auxiliary interface 98 for exterior lights of the vehicle. The vehicle interface subsystem 90 and/or control system 100 can include one or more controllers 84 which receive one or more commands 85 from the control system 100. The commands 85 can include route information 87 and one or more operational parameters 89 which specify an operational state of the vehicle (e.g., desired speed and pose, acceleration, etc.).

The controller(s) 84 generate control signals 119 in response to receiving the commands 85 for one or more of the vehicle interfaces 92, 94, 96, 98. The controllers 84 use the commands 85 as input to control propulsion, steering, braking and/or other vehicle behavior while the autonomous vehicle 10 follows a route. Thus, while the vehicle 10 may follow a route, the controller(s) 84 can continuously adjust and alter the movement of the vehicle in response receiving a corresponding set of commands 85 from the control system 100. Absent events or conditions which affect the confidence of the vehicle in safely progressing on the route, the control system 100 can generate additional commands 85 from which the controller(s) 84 can generate various vehicle control signals 119 for the different interfaces of the vehicle interface subsystem 90.

According to examples, the commands 85 can specify actions that are to be performed by the vehicle 10. The actions can correlate to one or multiple vehicle control mechanisms (e.g., steering mechanism, brakes, etc.). The commands 85 can specify the actions, along with attributes such as magnitude, duration, directionality or other operational characteristic of the vehicle 10. By way of example, the commands 85 generated from the control system 100 can specify a relative location of a road segment which the autonomous vehicle 10 is to occupy while in motion (e.g., change lanes, move to center divider or towards shoulder, turn vehicle etc.). As other examples, the commands 85 can specify a speed, a change in acceleration (or deceleration) from braking or accelerating, a turning action, or a state change of exterior lighting or other components. The controllers 84 translate the commands 85 into control signals 119 for a corresponding interface of the vehicle interface subsystem 90. The control signals 119 can take the form of electrical signals which correlate to the specified vehicle action by virtue of electrical characteristics that have attributes for magnitude, duration, frequency or pulse, or other electrical characteristics.

In an example of FIG. 1, the control system 100 includes perception logic 118, a route planner 122, motion planning logic 124, event logic 174, prediction engine 126, and a vehicle control 128. The vehicle control 128 represents logic that controls the vehicle with respect to steering, lateral and forward/backward acceleration and other parameters, in response to determinations of various logical components of the control system 100.

The perception logic 118 may receive and interpret the sensor data 111 for perceptions 123. The perceptions 123 can correspond to interpreted sensor data, such as (i) image, sonar or other electronic sensory-based renderings of the environment, (ii) detection and classification of objects in the environment, and/or (iii) state information associated with individual objects (e.g., whether object is moving, pose of object, direction of object). The perception logic 118 can interpret the sensor data 111 for a given sensor horizon. In some examples the perception logic 118 can be centralized, such as residing with a processor or combination of processors in a central portion of the vehicle. In other examples, the perception logic 118 can be distributed, such as onto the one or more of the sensor interfaces 110, 112, 114, such that the outputted sensor data 111 can include perceptions.

Objects which are identified through the perception logic 118 can be perceived as being static or dynamic, with static objects referring to environmental objects which are persistent or permanent in the particular geographic region. The perceptions 123 can be provided to the prediction engine 126, which can model detected and classified objects for predicted movement or position (collectively “predictions 139”) over a given duration of time. In some examples, the predictions 139 can include a probability of action, path or other movement which a dynamic object may make take a future span of time. For example, the prediction engine 126 can implement a model to determine a set of likely (or most likely) trajectories a detected person may take in a 5 second following when the person is detected, or for an anticipated duration of time from when the object is first detected.

The perceptions 123 and the predictions 139 can provide input into the motion planning component 124. The motion planning component 124 includes logic to detect dynamic objects of the vehicle's environment from the perceptions. When dynamic objects are detected, the motion planning component 124 determines a response trajectory 125 of the vehicle for steering the vehicle outside of the current sensor horizon. The response trajectory 125 can be used by the vehicle control interface 128 in advancing the vehicle forward.

The route planner 122 can determine a route 121 for a vehicle to use on a trip. In determining the route 121, the route planner 122 can utilize a map data base, such as provided over a network through a map service 119. Based on input such as destination and current location (e.g., such as provided through GPS), the route planner 122 can select one or more route segments that collectively form a path of travel for the autonomous vehicle 10 when the vehicle in on a trip. In one implementation, the route planner 122 can determine route input 173 (e.g., route segments) for a planned route 121, which in turn can be communicated to the vehicle control 128.

The vehicle control interface 128 can include a route following component 167 and a trajectory following component 169. The route following component 167 can receive route input 173 from the route planner 122. Based at least in part on the route input 173, the route following component 167 can output trajectory components 175 for the route 121 to the vehicle control interface 128. The trajectory follower 169 can receive the trajectory components 175 of the route follower 167, as well as the response trajectory 125, in controlling the vehicle on a vehicle trajectory 179 of route 121. At the same time, the response trajectory 125 enables the vehicle 10 to make adjustments to predictions of the predictive engine 126. The vehicle control interface 128 can generate commands 85 as output to control components of the vehicle 10. The commands can further implement driving rules and actions based on various context and inputs.

In some examples, the perception logic 118 can also include localization and pose logic (“LP logic 125”). The LP logic 125 can utilize sensor data 111 that is in the form of Lidar, stereoscopic imagery, and/or depth sensors in order to determine a localized position and pose of the vehicle. For example, the LP logic 125 can identify an intra-road segment location 133 for the vehicle within a particular road segment. The intra-road segment location 133 can include contextual information, such as marking points of an approaching roadway where potential ingress into the roadway (and thus path of the vehicle) may exist. The intra-road segment location 133 can be utilized by, for example, event logic 174, prediction engine 126, and/or vehicle control 128, for purpose of detecting potential points of interference or collision on the portion of the road segment in front of the vehicle. The intra-road segment location 133 can also be used to determine whether detected objects can collide or interfere with the vehicle 10, and response actions that are determined for anticipated or detected events.

With respect to an example of FIG. 1, the vehicle control interface 128 can include event logic 174. In some examples, route follower 167 implements event logic 174 detect an event (e.g., collision event) and to trigger a response to a detected event. A detected event can correspond to a roadway condition or obstacle which, when detected, poses a potential threat of collision to the vehicle 10. By way of example, a detected event can include an object in the road segment, heavy traffic ahead, and/or wetness or other environmental conditions on the road segment. The event logic 174 can use perceptions 123 as generated from the perception logic 118 in order to detect events, such as the sudden presence of objects or road conditions which may collide with the vehicle 10. For example, the event logic 174 can detect potholes, debris, and even objects which are on a trajectory for collision. Thus, the event logic 174 detects events which, if perceived correctly, may in fact require some form of evasive action or planning.

When events are detected, the event logic 174 can signal an event alert 135 that classifies the event and indicates the type of avoidance action which should be performed. For example, an event can be scored or classified between a range of likely harmless (e.g., small debris in roadway) to very harmful (e.g., vehicle crash may be imminent). In turn, the route follower 167 can adjust the vehicle trajectory 179 of the vehicle to avoid or accommodate the event. For example, the route follower 167 can output an event avoidance action, corresponding to a trajectory altering action that the vehicle 10 should perform to affect a movement or maneuvering of the vehicle 10. By way of example, the vehicle response can include a slight or sharp vehicle maneuvering for avoidance, using a steering control mechanism and/or braking component. The event avoidance action can be signaled through the commands 85 for controllers 84 of the vehicle interface subsystem 90.

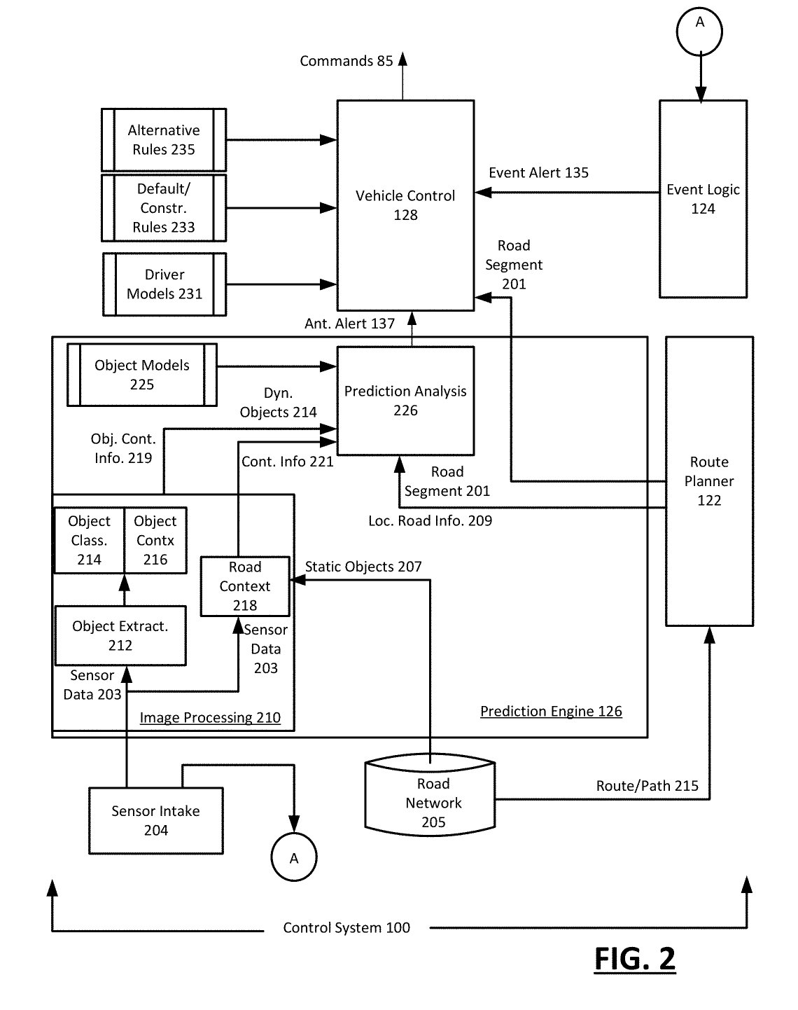

As described with examples of FIG. 2, the prediction engine 126 can operate to anticipate events that are uncertain to occur, but would likely interfere with the progress of the vehicle on the road segment should such events occur. The prediction engine 126 can also determine or utilize contextual information that can also be determined from further processing of the perceptions 123, and/or information about a traversed road segment from a road network.

According to some examples, the prediction engine 126 processes a combination or subset of the sensor data 111 and/or perceptions 123 in determining the predictions 139. The predictions 139 can also include, or be based on, an interference value 129 (shown as “IV 129”) which reflects a probability that an object of a particular type (e.g., pedestrian, child, bicyclist, skateboarder, small animal, etc.) will move into a path of collision or interference with the vehicle 10 at a particular point or set of points of the roadway. In this manner, the prediction engine 126 can improve safety of both the passengers in the vehicle and those who come within the vicinity of the vehicle. Moreover, by utilizing the prediction engine 126 to better anticipate a greater range of unseen events with more accuracy, the vehicle is able to be driven more comfortably with respect to passengers (e.g., fewer sudden brakes or movements). The prediction engine 126 can also utilize the route input 173 and/or intra-road segment location 133 to determine individual points of a portion of an upcoming road segment where a detected or occluded object can ingress into the path of travel. In this way, the prediction 139 can incorporate multiple parameters or values, so as to reflect information such as (i) a potential collision zone relative to the vehicle, (ii) a time when collision or interference may occur (e.g., 1-2 seconds), (iii) a likelihood or probability that such as event would occur (e.g., “low” or “moderate”), and/or (iv) a score or classification reflecting a potential magnitude of the collision or interference (e.g., “minor”, “moderate” or “serious”).

As described with some examples, the predictions 139 can be determined at least in part from predictive object models 185, which can be tuned or otherwise weighted for the specific geographic region and/or locality. In some examples, the prediction engine 126 determines a prediction 139 by which the vehicle 10 can be guided through an immediate field of sensor view (e.g., 5 seconds of time). The predictive object models 185 can predict a probability of a particular motion by an object (such as into the path of the vehicle 10), given, for example, a position and pose of the object, as well as information about a movement (e.g., speed or direction) of the object. The use of predictive object models, such as described with an example of FIG. 1 and elsewhere, can accommodate variations in behavior and object propensity amongst geographic regions and localities. For example, in urban environments which support bicycle messengers, erratic or fast moving bicycles can be weighted against a collision with the vehicle (despite proximity and velocity which would momentarily indicate otherwise) as compared to other environments where bicycle riding is more structured, because the behavior of bicyclists in the former geographic region is associated intentional actions.

With respect to detected objects, in some implementations, the prediction engine 126 detects and classifies objects which are on or near the roadway and which can potentially ingress into the path of travel so as to interfere or collide with the autonomous vehicle 10. The detected objects can be off of the road (e.g., on sidewalk, etc.) or on the road (e.g., on shoulder or on opposite lane of road). In addition to detecting and classifying the object, the prediction engine 126 can utilize contextual information for the object and its surroundings to predict a probability that the object will interfere or collide with vehicle 10. The contextual information can include determining the object position relative to the path of the vehicle 10 and/or pose relative to a point of ingress with the path of the autonomous vehicle 10. As an addition or alternative, the contextual information can also identify one or more characteristics of the object's motion, such as a direction of movement, a velocity or acceleration. As described with other examples, the detected object, as well as the contextual information can be used to determine the interference value 129. In some examples, the interference value 129 for a detected object can be based on (i) the type of object, (ii) pose of the object, (iii) a position of the object relative to the vehicle's path of travel, and/or (iv) aspects or characteristics of the detected object's motion (such as direction of speed).

With respect to undetected or colluded objects, in some implementations, the prediction engine 126 can determine potential points of ingress into the planned path of travel for the vehicle 10. The prediction engine 126 can acquire roadway information about an upcoming road segment from, for example, route planner 122 in order to determine potential points of ingress. The potential points of ingress can correlate to, for example, (i) spatial intervals extending along a curb that separates a sidewalk and road, (ii) spatial intervals of a parking lane or shoulder extending with the road segment, and/or (iii) an intersection. In some implementations, the prediction engine 126 processes the sensor data 111 and/or perceptions 123 to determine if the road segment (e.g., spatial intervals, intersection) are occluded.

If occlusion exists, the prediction engine 126 determines the interference value 129 for an unseen or undetected object, including unseen objects which may appear with no visual forewarning. As described with other examples, the determinations of the interference values 129 for both detected and undetected (or occluded objects) can be weighted to reflect geographic or locality specific characteristics in the behavior of objects or the propensity of such objects to be present.

In some examples, the interference value 129 includes multiple dimensions, to reflect (i) an indication of probability of occurrence, (ii) an indication of magnitude (e.g., by category such as “severe” or “mild”), (iii) a vehicle zone of interference or collision, and/or (iv) a time to interference or collision. A detected or undetected object can include multiple interference values 129 to reflect one or multiple points of interference/collision with the vehicle, such as multiple collision zones from one impact, or alternative impact zones with variable probabilities. The prediction engine 126 can use models, statistical analysis or other computational processes in determining a likelihood or probability (represented by the likelihood of interference value 129) that the detected object will collide or interfere with the planned path of travel. The likelihood of interference value 129 can be specific to the type of object, as well as to the geographic region and/or locality of the vehicle 10.

In some examples, the prediction engine 126 can evaluate the interference value 129 associated with individual points of ingress of the roadway in order to determine the response trajectory 175 for the vehicle 10. In other variations, the prediction engine 126 can determine whether an anticipatory alert 137 is to be signaled. The anticipatory alert 137 can result in the vehicle 10 performing an automatic action, such as slowing down (e.g., moderately). By slowing frequently and gradually as a form of implementing anticipatory alerts, the prediction engine 126 can enable a more comfortable ride for passengers. In some implementations, prediction engine 126 can compare the interference value 129 to a threshold and then signal the anticipatory alert 137 when the threshold is met. The threshold and/or interference value 129 can be determined in part from the object type, so that the interference value 129 can reflect potential harm to the vehicle or to humans, as well as probability of occurrence. The anticipatory alert 137 can identify or be based on the interference value 129, as well as other information such as whether the object is detected or occluded, as well as the type of object that is detected. The vehicle control 128 can alter control of the vehicle 10 in response to receiving the anticipatory alert 137.

In some examples, the prediction engine 126 determines possible events relating to different types or classes of dynamic objects, such as other vehicles, bicyclists or pedestrians. In examples described, the interference value 129 can be calculated to determine which detected or undetected objects should be anticipated through changes in the vehicle operation. For example, when the vehicle 10 drives at moderate speed down a roadway, the prediction engine 126 can anticipate a sudden pedestrian encounter as negligible. When however, contextual information from the route planner 122 indicates the road segment has a high likelihood of children (e.g., school zone), the prediction engine 126 can significantly raise the interference value 129 whenever a portion of the side of the roadway is occluded (e.g., by a parked car). When the interference value 129 reaches a threshold probability, the prediction engine 126 signals the anticipatory alert 137, resulting in the vehicle 10 performing an automated action 147 (e.g., slowing down). In variations, the prediction engine 126 can communicate a greater percentage of anticipatory alerts 137 if the anticipatory action is negligible and the reduction in probability is significant. For example, if the threat of occluded pedestrians is relatively small but the chance of collision can be eliminated for points of ingress that are more than two car lengths ahead with only a slight reduction in velocity, then under this example, the anticipatory alert 137 can be used by the vehicle control 128 to reduce the vehicle velocity, thereby reducing the threat range of an ingress by an occluded pedestrian to points that are only one car length ahead of the vehicle 10.

In some examples, the prediction engine 126 can detect the presence of dynamic objects by class, as well as contextual information about the detected object, such as speed, relative location, possible point of interference (or zone of collision), pose, and direction of movement. Based on the detected object type and the contextual information, the prediction engine 126 can signal an anticipatory alert 137 which can indicate information such as (i) a potential collision zone (e.g., front right quadrant 20 feet in front of vehicle), (ii) a time when collision or interference may occur (e.g., 1-2 seconds), (iii) a likelihood or probability that such as event would occur (e.g., “low” or “moderate”), and/or (iv) a score or classification reflecting a potential magnitude of the collision or interference (e.g., “minor”, “moderate” or “serious”). The vehicle control 128 can respond to the anticipatory alert 137 by selecting an anticipatory action 147 for the vehicle 10. The anticipatory action 147 can be selected from, for example, an action corresponding to (i) slowing the vehicle 10 down, (ii) moving the lane position of the vehicle away from the bike lane, and/or (iii) breaking a default or established driving rule such as enabling the vehicle 10 to drift past the center line. In such examples, the magnitude and type of anticipatory action 147 can be based on factors such as the probability or likelihood score, as well as the school or classification of potential harm resulting from the anticipated interference or collision.

As an example, when the autonomous vehicle 10 approaches bicyclists on the side of the road, examples provide that the prediction engine 126 detects the bicyclists (e.g., using Lidar or stereoscopic cameras) and then determines an interference value 129 for the bicyclist. Among other information which can be correlated with the interference value 129, the prediction engine 126 determines a potential zone of collision based on direction, velocity and other characteristics in the movement of the bicycle. The prediction engine 126 can also obtain and utilize contextual information about the detected object from corresponding sensor data 111 (e.g., image capture of the detected object, to indicate pose etc.), as well as intra-road segment location 133 of the road network (e.g., using information route planner 122). The sensor detected contextual information about a dynamic object can include, for example, speed and pose of the object, direction of movement, presence of other dynamic, and other information. For example, when the prediction engine 126 detects a bicycle, the interference value 129 can be based on factors such as proximity, orientation of the bicycle, and speed of the bicycle. The interference value 129 can determine whether the anticipatory alert 137 is signaled. The vehicle control 128 can use information provided with the interference value to determine the anticipatory action 147 that is to be performed.

When an anticipated dynamic object of a particular class does in fact move into position of likely collision or interference, some examples provide that event logic 174 can signal the event alert 135 to cause the vehicle control 128 to generate commands that correspond to an event avoidance action. For example, in the event of a bicycle crash in which the bicycle (or bicyclist) falls into the path of the vehicle 10, event logic 174 can signal the event alert 135 to avoid the collision. The event alert 135 can indicate (i) a classification of the event (e.g., “serious” and/or “immediate”), (ii) information about the event, such as the type of object that generated the event alert 135, and/or information indicating a type of action the vehicle 10 should take (e.g., location of object relative to path of vehicle, size or type of object,).

The vehicle control 128 can use information provided with the event alert 135 to perform an event avoidance action in response to the event alert 135. Because of the preceding anticipatory alert 137 and the anticipatory action 147 (e.g., vehicle slows down), the vehicle 10 can much better avoid the collision. The anticipatory action 147 is thus performed without the bicyclists actually interfering with the path of the vehicle. However, because an anticipatory action 147 is performed, in the event that the detected object suddenly falls into a path of collision or interference, the vehicle control logic 128 has more time to respond to the event alert 135 with an event avoidance action, as compared to not having first signaled the anticipatory alert 137.

Numerous other examples can also be anticipated using the control system 100. For dynamic objects corresponding to bicyclists, pedestrians, encroaching vehicles or other objects, the prediction engine 126 can perform the further processing of sensor data 111 to determine contextual information about the detected object, including direction of travel, approximate speed, roadway condition, and/or location of object(s) relative to the vehicle 10 in the road segment. For dynamic objects corresponding to pedestrians, the prediction engine 126 can use, for example, (i) road network information to identify crosswalks, (ii) location specific geographic models identify informal crossing points for pedestrians, (iii) region or locality specific tendencies of pedestrians to cross the roadway at a particular location when vehicles are in motion on that roadway (e.g., is a pedestrian likely ‘jaywalk’), (iv) proximity of the pedestrian to the road segment, (v) determination of pedestrian pose relative to the roadway, and/or (vi) detectable visual indicators of a pedestrian's next action (e.g., pedestrian has turned towards the road segment while standing on the sidewalk). Additionally, the prediction engine 126 can interpret actions or movements of the pedestrian, who may, for example, explicitly signal the Vehicle as to their intentions. Thus, the prediction engine 126 can interpret motions, movements, or gestures of the pedestrians, and moreover, tune the interpretation based on geography, locality and other parameters.

For dynamic objects corresponding to bicyclists, the prediction engine 126 can use, for example, (i) road network information to define bike paths alongside the roadway, (ii) location specific geographic models identify informal bike paths and/or high traffic bicycle crossing points, (iii) proximity of the pedestrian to the road segment, (iv) determination of bicyclists speed or pose, and/or (v) detectable visual indicators of the bicyclists next action (e.g., cyclist makes a hand signal to turn in a particular direction).

Still further, for other vehicles, the prediction engine 126 can anticipate movement that crosses the path of the autonomous vehicle at locations such as stop-signed intersections. While right-of-way driving rules may provide for the first vehicle to arrive at the intersection to have the right of way, examples recognize that the behavior of vehicles at right of ways can sometimes be more accurately anticipated based on geographic region. For example, certain localities tend to have aggressive drivers as compared to other localities. In such localities, the control system 100 for the vehicle 10 can detect the arrival of a vehicle at a stop sign after the arrival of the autonomous vehicle. Despite the late arrival, the control system 100 may watch for indications that the late arriving vehicle is likely to forego right of way rules and enter into the intersection as the first vehicle. These indicators can include, for example, arrival speed of the other vehicle at the intersection, braking distance, minimum speed reached by other vehicle before stop sign, etc.

FIG. 2 illustrates an example implementation of a prediction engine in context of a control system for the autonomous vehicle. More specifically, in FIG. 2, the autonomous vehicle control system 100 includes route planner 122, event logic 174, and prediction engine 126. FIG. 2 illustrates an example implementation of a prediction engine in context of a control system for the autonomous vehicle. More specifically, in FIG. 2, the autonomous vehicle control system 100 includes route planner 122, the event logic 174, and prediction engine 126.

In an example of FIG. 2, the prediction engine 126 implements subcomponents which include an image processing component 210 and prediction analysis 226. In some variations, some or all of the image processing component 210 form part of the perception logic 118. While examples describe use of image processing with respect to operations performed by the sensor processing component 210, variations provide analysis of different types of sensor data as an addition or alternative to analysis performed for image data. The sensor processing component 210 can receive image and other sensor data 203 (“image and/or sensor data 203”) from a sensor intake component 204. The image and/or sensor data 203 can be subjected to processes for object extraction 212, object classification 214, and object contextual component 216. The object extraction 212 processes the image and/or sensor data 203 to detect and extract image data that corresponds to a candidate object. The object classification 214 can determine whether the extracted candidate object is an object of a predetermined class. For example, the object classification 214 can include models that are trained to determine objects that are pedestrians, bicyclists, or other vehicles. The object contextual component 216 can process the image and/or sensor data 203 of the detected object in order to identify contextual information of the object itself, for purpose of enabling subsequent prediction analysis. According to some examples, the object contextual component 216 can process the image and/or sensor data 203 in order to identify visual indicators of the detected object which are indicative of the object's subsequent movement.

In an example of FIG. 2, the sensor processing component 210 includes a road contextual component 218 which detects a surrounding contextual information for a detected object. The road contextual component 218 can operate to receive information such as provided by the static objects 207 and/or localized road information 209, in order to determine and map contextual information that is known to exist in the roadway to what is actually observed via the image and/or sensor data 203. The road contextual component 218 can determine information about the detected object, such as the pose, orientation or direction of movement, speed of movement, or other visual markers of the detected object which indicate a potential next action of the detected object (e.g. hand signal from a bicyclist). The road contextual component 218 can also determine image-based, real-time contextual information 219, such as an amount of traffic, a road condition, environmental conditions which can affect the vehicle response, and/or other information relevant for determining dynamic objects on the road segment.

According to some examples, the sensor processing component 210 can perform image recognition and/or analysis in order to (i) detect objects which are moving or can move and which are in the field of view of the sensors for the autonomous vehicle 10, and (ii) determine contextual object information 213 for the detected object, as determined by object context component 216. For example, the sensor processing component 210 can analyze the image and/or sensor data 203 in order to detect shapes that are not known to be static objects 207. The object extraction 212 and object classifier 214 can operate to detect candidate dynamic objects (e.g., human forms) from the image and/or sensor data 203. Additionally, object context component 216 can process the image and/or sensor data 203, with specific attention to the detected objects, in order to determine object context information 219 about the detected object. The contextual object information 213 can facilitate confirmation of whether the detected object is a dynamic object of a particular type. Furthermore, the contextual object information 213 can provide information about the pose of the detected object, as well as information about the manner in which the object is moving (e.g., orientation of movement, speed, etc.), and/or other visual markers which are indicative of a future action of the dynamic object.

In some variations, the contextual object information 213 can be specific to the class of object that is detected. For example, if the detected object is a person, the contextual object information 213 can process image data to detect facial features, and specifically to detect the orientation of the face or eyes from the detected facial features of the person. In turn, the contextual information about the face and eyes can be predictive of a next action of the person. For example, the pose and eyes of the person can indicate whether the person will move in a given region.

As another example that is specific to bicycles, contextual information can be detected from processing the image and/or sensor data 203 in order to determine a visual marker that is specific to bicycles. For example, the object context component 216 can process the image and/or sensor data 203 to determine when the corresponding bicyclist has his arm out in a particular direction, so as to indicate a direction of travel.

In some variations, sensor processing component 210 receives an image map of a current road segment, depicting information such as static objects 207 which are known to be on the roadway. According to one implementation, the road network database 205 includes a repository of information that identifies static objects 207, based on image and sensor data provided by prior use of the vehicle 10 and/or other vehicles. For example, the same or other autonomous vehicles can be operated through road segments to capture various kinds of sensor data, which can subsequently be analyzed to determine static objects 207. The road network database 205 can be accessed by, for example, the road contextual component 218, which can generate or otherwise process a map that identifies or otherwise depicts the static objects 207 with accuracy on the roadway. The road contextual component 218 can be used to label a detected object from the image and/or sensor data with surrounding contextual information 221. For example, the surrounding contextual information 221 can provide an indication of whether a bike lane exists on the side of the road, as well as whether roadway features exist which make it less likely or more likely for the bicyclists to enter the path of the autonomous vehicle 10.

According to one example, the route planner 122 can access the road network database 205 to retrieve route segments or path information (“route/path 215”) for a planned route or path of the autonomous vehicle 10. The road network database 205 can populate road segments with precise locations of fixed objects. In this way, the route planner 122 can process the road segment in context of the vehicle's intra-road segment location 133, and further provide road information that provides highly localized road information 209 about the road segment and surrounding fixed objects 207. In some variations, the road network database 205 can include preprocessed image data that provides intra-road segment localization information. The preprocessed image data can identify the static objects 207, including objects on the periphery of the road segment (e.g., sidewalk, side of road, bike lane, etc.) which are fixed in position. Examples of static objects 207 include trees, sidewalk structures, street signs, and parking meters.

According to some examples, the prediction analysis 226 can utilize input from the sensor processing component 210 and the route planner 122 in order to anticipate a likelihood or probability that an object of one or more predetermined classes (e.g., persons, bicycles, other vehicles) will interfere or collide with the path of the autonomous vehicle 10. When the analysis indicates that an interference value 229 of an object colliding or interfering with the vehicle 10 exceeds a threshold, the prediction engine 126 can signal the anticipatory alert 137. As described with an example of FIG. 1, the interference value 229 can correlate (i) probability of occurrence, based on object type, contextual information, and models (e.g., object model 225), and (ii) object type (including occluded or undetected). When a magnitude of the interference value 229 exceeds a threshold, the prediction analysis 226 signals the anticipatory alert 137. The threshold for the interference value can also be based on, for example, the default settings, the type of object, and/or a classification or measure of harm from an object that is being analyzed.

In one implementation, the prediction analysis 226 receives an identifier from the object classification 214, as well as image-based contextual information 219 pertaining to the detected dynamic object and/or surrounding contextual information 221 from the scene or near the object. The combination of information provided as input to the prediction analysis component 226 from the sensor processing component 210 can identify a dynamic object of a particular class (e.g., vehicle, bicycle, pedestrian), as well as object context information 219 that may indicate, for example, the location or proximity of the object to the road segment, the pose of the object, and/or movement characteristics of the object (e.g., orientation and direction of movement). Additionally, the input from the sensor processing component 210 can include other markers that indicate a potential next action of the detected object.

According to some examples, the prediction analysis 226 can utilize models 225 (and/or rules and other forms of logic) that are specific to the object type (e.g., bicycles, pedestrians, vehicle, skateboarders, dogs etc.) in order to determine an anticipated event of sufficient probability or likelihood to merit signaling the anticipatory alert 137. The models can be built using machine learning, using for example, labeled data (e.g., using sensor classification from sources such as other vehicles). The object models 225 can, for example, predict behavior of movers for a given duration of time (e.g., five seconds), such as from the time the vehicle encounters the object until when the vehicle has safely passed the object. The vehicles can also observe objects for such windows of time (e.g., five seconds) in order to develop and tune the object models 225. In some examples, the object models 225 can also be specific to the geographic region and/or to a locality of a geographic region (e.g., specific city blocks). As an example, region-specific models 225 can weight or select models with regard to the behavior of bicyclists, pedestrians and vehicles. The region-specific aspect of object models 225 can accommodate population behavior and roadway planning that is specific to a particular country, city, neighborhood, or more specific localities such as city block. With the use of region specific models, examples recognize that the behavior of dynamic objects (e.g., persons, bicycles, or vehicles) can be diverse across multiple geographic regions (e.g., states).

As another example, the object model 225 can weight characteristic of movement (e.g., velocity), pose and position based on what is normal in the given region. If bicycle messengers are, for example, prevalent in a particular locality, then the autonomous vehicle 10 can weight a fast moving bicycle that is close to the vehicle or briefly oriented towards the vehicle as being less of a threat for interference or collision, as compared to the same scenario in a different locality or geographic region. The prediction analysis 226 can communicate the anticipatory alert 137 to the vehicle control 128. In some variations, the anticipatory alert 137 can include multiple dimensions or parametric values, such as information that identifies the object, as well as object context information 219 and surrounding context information 221.

For example, in some cities, pedestrians are given right of away by vehicles in intersection crossings, such that vehicles come to complete stops when turning into a crosswalk at a red light, before inching forward when a gap appears in the crossing pedestrians. In other regions, however, vehicles may tend to assume the right-of-way through the crosswalk, even when pedestrians step into the crosswalk. Still further, some localities favor the use of bicycles, in that bicycles are given separately structured bicycle lanes which are immediately adjacent to the road segment, while in other localities (e.g., college towns), the presence of bicycles in traffic with vehicles is pervasive (e.g., cities with messengers, college towns). By utilizing geographic specific models, examples can predict different outcomes for detected classes of objects, based in part on model outcomes, as well as implementation of rules and/or other logic. Accordingly, in some examples, the models 225 are weighted by parameters and constants that are specific to a geographic region. For example, different geographic regions can use different models, or alternatively, different weights for the same model, in order to predict a probability or likelihood of a behavior of an object, which in turn can raise or lower a probability of collision or interference.

According to some examples, the predictive models 225 identifies dynamic objects by class, and further characterizes the presence of objects by object attributes that include, for example, pose, proximity of the object to the road segment, and movement characteristics (e.g., speed or orientation) of the detected object. The predictive models 225 can, for example, correlate the object attributes (e.g., pose, proximity to road segment, speed and direction of movement, etc.) to a probability or likelihood that the object will (i) ingress into the road segment, and/or (ii) interfere or collide with the path of the autonomous vehicle 10. In determining the probabilities, the predictive models 225 can also account for surrounding contextual information 221. For example, a fast moving bicycle can be deemed to pose a lesser risk if the bicycle is riding near the side of the street with a sparse number of parked or idled cars present. The presence of parked or idled cars on the side of the road is an example of surrounding contextual information 221 that can be determined from processing the image and/or sensor data 103 of the vehicle 10 in real-time. In one implementation, the model 225 includes weighted parameters which make a probability of the object ingressing into the road and/or interfering or colliding with the autonomous vehicle more or less likely.

The predictive models 225 and/or its variants can be determined in a variety of ways. In some examples, geographic regions are observed using cameras, which can be positioned on vehicles or at stationery locations, in order to observe the interactions of various types of objects (e.g., pedestrians, bicycles, vehicles) with road segments that an autonomous vehicle 10 may travel on. The vehicles which can be used for such modeling can include, for example, other autonomous vehicles, or vehicles which are used to provide transport services through a particular locality. The tendencies and manner in which such objects (as typically operated by people) interact with the roadway can be recorded. For example, behavior which can be recorded at a particular road segment of a geographic region and may include: (i) propensity of persons in the population to use a crosswalk when crossing the street; (ii) propensity of drivers to yield to persons crossing in the crosswalk; (iii) a frequency in which persons cross the street illegally, such as by way of outside of the crosswalk, or when traffic is present; (iv) speed of vehicles on specific road segments; (v) presence of bicyclists, including type of bicyclists (e.g., recreational enthusiast or messenger); (vi) whether vehicle stop or slow down, as well as the velocity by which vehicles progress through a turn at a red light, or through an intersection with the stop sign; (vii) actions performed by pedestrians prior to crossing the street, such as pressing for the pedestrian signal and are turning their heads left to right; and/or (viii) a general number of objects of predetermined types (e.g., number of bicyclists, pedestrians, and vehicles) that are near or on the roadway at different times of day.

In some examples, prediction analysis component 226 can operate in a cautionary manner to anticipate in unseen object. In particular, prediction analysis component 226 can operate to detect dynamic objects which may be occluded by structures to the vehicle 10. In some examples, the control system 100 of the vehicle 10 can implement a cautious mode in which a road segment is scanned to determine points of ingress into the path of the vehicle which are occluded by a structure, such as a parked car. When operating in a cautious mode, the prediction analysis component 226 can utilize the surrounding contextual information 221 to anticipate a worst-case event, such as an object (e.g., animal, bicyclists, small child) darting into the roadway in front of the vehicle. The localized road information 209, as well as the surrounding context information 221 can be used to determine where points of ingress into the path of the autonomous vehicle are occluded from the sensor devices of the autonomous vehicle 10. In such examples, the interference value 229 can be based on the presence of occlusion, and a propensity of objects (e.g., children or animals) that can suddenly move into the path of the vehicle from a point of the roadway which is occluded.

As described with an example of FIG. 1, the vehicle control 128 outputs commands 85 for controlling the vehicle 10 using the vehicle interface subsystem 90. The vehicle control 128 can be responsive to event alerts 135, as generated by event logic 174, which can signal the occurrence of an event that requires action. The vehicle control 128 can also be responsive to anticipatory alerts 137, in that the vehicle control 128 can, for example, perform certain kinds of actions to avoid an uncertain or even low probability threat.

According to some examples, the anticipatory alert 137 can be based on, or correlate to the interference value 229, so as to identify (i) the class of object that is of concern (e.g., pedestrian, bicycle, vehicle, unknown/occluded), (ii) a potential collision zone (e.g., front right quadrant 20 feet in front of vehicle), (iii) a time when collision or interference may occur (e.g., 1-2 seconds), (iv) a likelihood or probability that such as event would occur (e.g., “low” or “moderate”), and/or (v) a score or classification reflecting a potential magnitude of the collision or interference (e.g., “minor”, “moderate” or “serious”).

According to some examples, vehicle control 128 responds to the anticipatory alert 137 by determining the vehicle action needed to anticipate a potential event. For example, vehicle control 128 can determine a desired action (e.g., reduce velocity, move vehicle position in lane, change lanes, etc.) by issuing a series of commands to implement the desired action. For example, the autonomous vehicle 10 can operate reduce the speed of the vehicle, so as to permit additional time for the vehicle to respond should an object suddenly move in front of the vehicle 10. As another example, the vehicle control 128 can issue commands 85 to generate spatial separation between the vehicle and the potential point of ingress where an otherwise occluded object may enter the path of the vehicle 10. For example, the vehicle can move laterally in the lane to create additional buffer with the curb on which a pedestrian is standing.

According to some examples, the vehicle control 128 can implement alternative sets of rules and logic to control the manner in which the vehicle 10 responds to event alerts 135 and anticipatory alerts 137, given input about the particular road segment 201 which the vehicle 10 is travelling on. According to some examples, vehicle control 128 implements default rules and constraints 233 in planning responses to event and/or anticipatory alerts 135, 137. The default rules and constraints 233 can be based on formal or legal requirements for operating a motor vehicle, such as the position the vehicle can take within a lane or side of the road. For example, roadways sometimes have solid line dividers, double line dividers, dashed dividers or no dividers separating two lanes of traffic. While vehicles are generally required to stay inside of a solid or double line divider, examples recognize that human drivers accommodate bicyclists and non-vehicular objects on the side of the road by drifting over in the lane, even to the point where a solid line or double line is crossed.

According to some examples, the vehicle control 128 can selectively implement alternative flex rules 235 which enable the vehicle to perform actions which may implement alternative spatial location or margin constraints, and/or implement other actions which technically break a rule or margin of one or more default rules and constraints 233. The alternative flex rules 235 can, in some cases break rules of best driving practice, or even technically violate a driving law. The flex rules 235 can be implemented in place of increasing safety to vehicles or bystanders. For example, with respect to objects (e.g., bicyclists) sees on the side of the road, the vehicle control 128 can drift away from the side of the road to create a buffer with a dynamic object (e.g. bicycle). In performing this action, the vehicle control 128 may technically break the requirement to stay within a solid line divider if information provided from the anticipatory alert 137 indicates that the additional space would increase safety to the vehicle and/or object on the side of the road.

As another example, the vehicle control 128 can selectively implement alternative flex rules 235 with regards to the manner in which the autonomous vehicle 10 encroaches into an intersection when multiple right-of-way considerations are present. The default rule and constraints 233 may specify that the autonomous vehicle 10 in encroach into an intersection after completing a stop, based on a determination of right-of-way coinciding with when each vehicle at the intersection came to a stop. The presence of multiple vehicles at an intersection can generate the anticipatory alert 137, which may in turn cause the vehicle to follow a different right-of-way rule. For example, the autonomous vehicle 10 may implement an alternative flex rule 235 in which vehicles that arrive at the stop sign after the autonomous vehicle 10 are given right-of-way over the autonomous vehicle when the other vehicles come to a sufficiently slow speed to simulate a stop within a threshold time period from when the autonomous vehicle 10 arrived.

Still further, the response actions of the vehicle control 128 can be based on driver models 231. The driver models 231 can reflect driving behaviors and responses from actual drivers of a given geographic region.

According to some examples, model drivers can be selected from a given geographic region to carry a sensor set (e.g., cameras) that records the behaviors of bicyclists, pedestrians, vehicles or other objects with respect to the roadway. The model drivers can also carry equipment for collecting sensor information that reflects the manner in which the vehicle is driven, such as (i) accelerometers or inertial mass units (IMUs) to detect braking, vehicle acceleration and/or turning from the vehicle under operation of the model driver; and/or (ii) devices to collect vehicle information, such as Onboard Diagnostic Data (“OBD”). The collected sensor information relating to operation of the vehicle of the model driver can be correlated in time to perceived sensor events captured through the cameras. From the collected information, data and information can be obtained for modeling dynamic objects which are typically encountered in the identified geographic region, as well as alternative flex rules which are typically, or can be alternatively implemented at a particular locality. In variations, the model driver data can also be used to identify driving behaviors which are predictive (for human perception). For example, model drivers may be observed to drive slowly through certain areas, and observance of such events can be correlated to predictive driving behavior for an autonomous vehicle.

Methodology

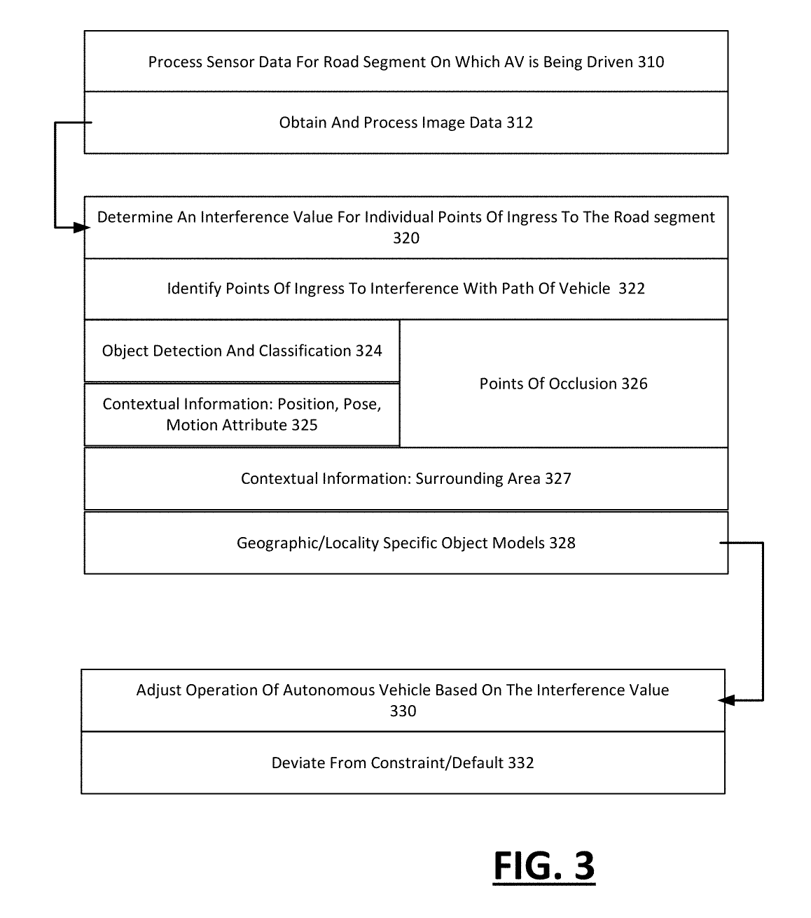

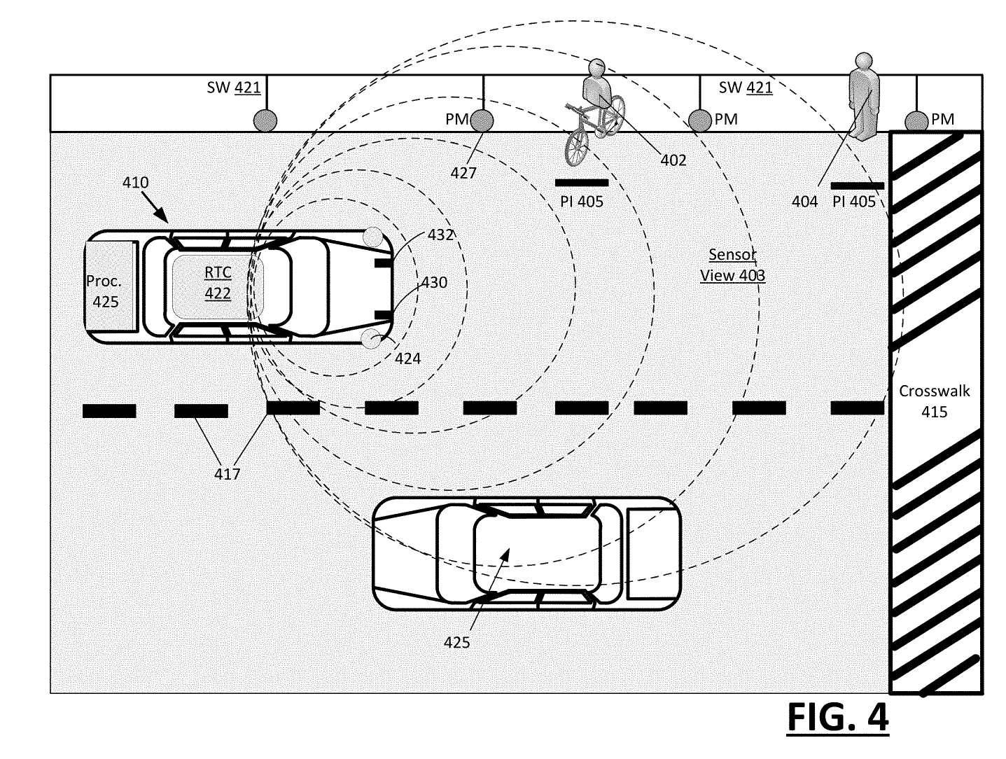

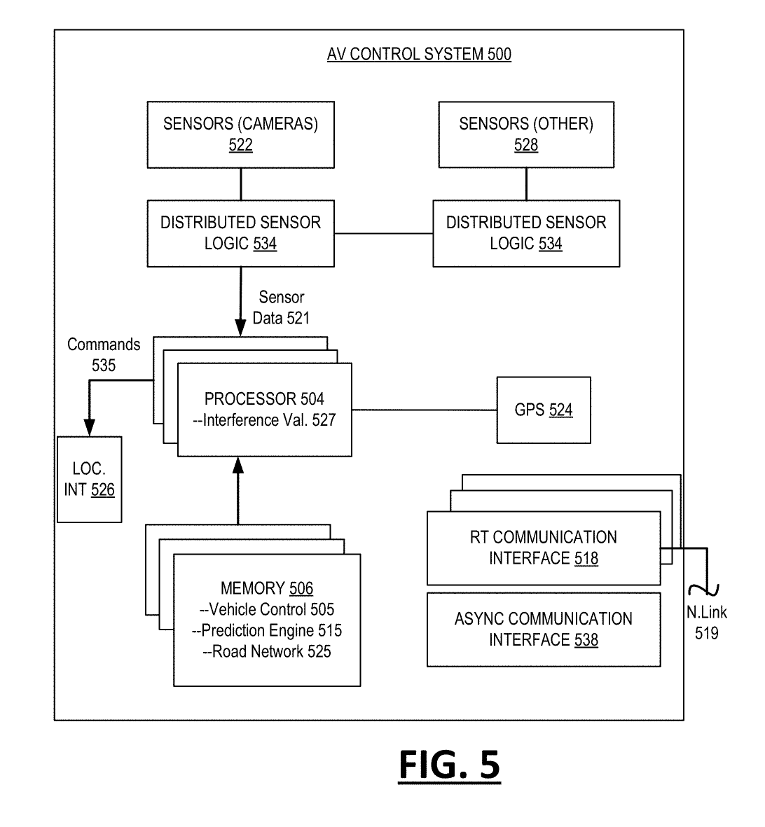

FIG. 3 illustrates an example method for operating an autonomous vehicle to anticipate events. FIG. 4 illustrates an example of an autonomous vehicle that can operate predictively to anticipate objects which can interfere or collide with the vehicle. FIG. 5 is a block diagram that illustrates a control system for an autonomous vehicle upon which embodiments described herein may be implemented. In describing an example of FIG. 3, reference may be made to elements or components of examples of FIG. 1 or FIG. 2, for purpose of illustrating a suitable component or element for performing a step or sub-step being described.

With reference to an example of FIG. 3, the control system 100 of the vehicle 10 can process sensor data that reflects an immediate portion of the planned path for the vehicle 10(310). The sensor data can include image data (312), such as stereoscopic image data (with or without depth information), Lidar, high resolution video and/or still imagery. Other forms of sensor data for analysis can include, for example, radar, sonar, or GPS.

The control system 100 can determine an interference value for individual points of ingress in a portion of a planned path of the vehicle 10 (320). In determining the interference value, the control system 100 can use road way information, stored information and/or information determined from prior runs of sensor-equipped vehicles in order to identify points of ingress where objects can interfere or collide with the planned path of the vehicle 10 (322).

An interference value can be determined for detected objects and/or undetected objects that coincide with points of ingress which are occluded. In one implementation, the control system 100 analyzes the image data from a perspective or scene which encompasses the roadway and the region outside or adjacent to the roadway, such as bike lanes, shoulders, parking lanes, sidewalks, and regions between sidewalks and roadways. The image data can be analyzed in relation to individual points of the road segment where objects can cross into the path of the vehicle 10.

In an example such as shown by FIG. 2, control system 100 uses image processing component 210 in order to identify and classify objects that are in motion, or capable of motion, and further sufficiently near the planned path of the vehicle to have ability to interfere or collide with the vehicle (324). The sensor information (including image processing) can further be used to determine contextual information about the object (325), such as the object's pose, position relative to the road or path of the vehicle, the object's direction of movement and velocity, and other information (including object specific contextual information).

As an addition or variation, the control system 100 uses image processing component 210 to identify points along the road segment which are occluded, such that an undetected object of a particular class can be hidden while at the same time being a threat to interfere or collide with the vehicle 10 (326). For example, occlusion can be the result of a parked vehicle or track, or as a result of fixed objects (e.g., large tree). If sufficient occlusion exists where a hidden object can suddenly move in front of the vehicle 10, then an interference value can be determined and associated with individual points of the roadway which are occluded at a particular instance in time by a given object or set of objects. The control system 100 can determine an interference value that reflects, for example, a type of object which can be anticipated as being present, the proximity of the object, and a probability that an anticipated object is present.

Additionally, the sensor information and/or road network can be used to determine contextual information about the surrounding region of the object or occlusion (327). The surrounding contextual information can be used to further weight, for example, predictive modes for detected objects and/or undetected occluded objects.

More generally, one or more predictive models can be used to determine interference values for specific object types (e.g., pedestrians, bicyclists, vehicles). The interference value for a detected object can be based on the object type, the contextual information that is determined for the detected object. In this way, the objects that are detected and classified can be associated with an interference value and with one or more points of ingress into the path of the vehicle 10.

According to some examples, in determining the probability and the type of object which may be present at points of the roadway (including at points of occlusion), the control system 100 can use geographic or locality specific models which are weighted in favor of detecting specific types of objects (328). For example, a geographic region may be observed to include cats or other small animals, as well as children within specific blocks that are near schools and parks. In such cases, the control system 100 can weight the determination of interference value for undetected or occluded objects to anticipate sudden movements by cats or children. Likewise, for detected objects, the probability that a detected object will interfere with the path of the vehicle 10 can be better estimated by object models which model the behavior of such objects with specific weights or considerations for the geographic region or locality.

According to some examples, the control system 100 can adjust the operation of the autonomous vehicle 10 based on the determined interference value (330). The interference value can have multiple dimensions, so as to correlate to parametric values, so as to (i) identify the class of object that is of concern (e.g., pedestrian, bicycle, vehicle, unknown/occluded), (ii) a potential collision zone, (iii) a time when collision or interference may occur (e.g., 0-3 seconds), (iv) a likelihood or probability that such as event would occur (e.g., “low” or “moderate”), and/or (v) a score or classification reflecting a potential magnitude of the collision or interference (e.g., “minor”, “moderate” or “serious”). The control system 100 can respond to, for example, an anticipatory alert 137 which signals interference values by deviating from a default set of driving rules (332). The response of the control system 100 can deviate from the default set of driving rules based on the interference value, and other facets such as driving convention for the relevant geographic region or locality.

FIG. 4 illustrates an example of an autonomous vehicle that can operate predictively to anticipate objects which can interfere or collide with the vehicle. In an example of FIG. 4, an autonomous vehicle 410 includes various sensors, such as roof-top cameras 422, front cameras 424 and radar or sonar 430, 432. A processing center 425, comprising a combination of one or more processors and memory units can be positioned in a trunk of the vehicle 410.

According to an example, the vehicle 410 uses one or more sensor views 403 (e.g., field of view of camera) to scan a road segment on which the vehicle 410 is about to traverse as part of a trip. The vehicle 410 can process image data, corresponding to the sensor views 403 of one or more cameras in order to detect objects that are moving or can move into the path of the vehicle 10. In an example shown, the detected objects include a pedestrian a bicycle 402, a pedestrian 404, and another vehicle 406, each of which having potential to cross into a road segment 415 on which the vehicle is to traverse. The vehicle 410 can use information about the road segment and/or image data from the view 403 to determine that the road segment includes a divider 417 and an opposite lane, as well as a sidewalk 421 and sidewalks structures such as parking meters 427. The parking meters 427 provide an example of fixed objects, meaning objects which appear in the scene of an encroaching vehicle which are unable to move.

According to examples as described, the vehicle 410 makes anticipatory determinations about the dynamic objects (those objects which can move). In an example of FIG. 4, the dynamic objects can include the bicycle 402, pedestrian 404 and the other vehicle 406. For each class of object, the processors of the vehicle 410 can implement the control system 100 to determine an interference value, corresponding to the identified object moving into the path of the vehicle 410.

As described with other examples, in determining the probability that the bicycle 402 will interfere with the path of travel of the vehicle, the processing center 425 of the vehicle 410 can implement an object model (e.g., bicyclist) which can predict an action or movement of the object within a time period during which the object can move into the path of the vehicle 410. With respect to the bicycle 402, for example, the interference value can reflect the probability that the bicyclist will inadvertently ride into the path of the vehicle 410. As part of the interference value, a point of ingress 405, meaning the location where a detected object may cross into the road way and/or path of the vehicle 410 can be identified. Further, with respect to the bicycle 402, the action or movement that can be predicted include (i) the bicycle 402 moving in straight-line in front of the vehicle 410 (such as in the case when the bicyclists does not see the vehicle 410 when attempting to cross the street); or (ii) the bicyclist moving into the street to ride parallel with the vehicle 410. In determining the prediction using a corresponding object model 429, the processors 425 of the vehicle 410 can process sensor data from the cameras 422, 424, sonar 432, 434 ad/or other sources, combined with information know or retrieved about the road network, to determine contextual information.

The contextual information can be specific to the bicycle 402, so as to identify (i) a pose of the bicycle 402 with respect to the road segment (e.g., facing perpendicular to road), (ii) a position of the bicyclist 402 with respect to the road segment (e.g., distance, next to curb, between sidewalk and curb, etc.), and (iii) information about the motion of the bicyclist 402 (e.g., whether the bicyclist is moving, speed of movement, direction of movement). More specific or granular information can also be obtained, such as the orientation or pose of the rider. The object model for the bicyclist can in turn provide an interference value, based on the contextual information.

In some examples, the object model for a given class of objects (e.g., bicyclist) can be selected from multiple possible object models based on geographic region or locality. In variations, the object model for a class of object can be, weighted or otherwise configured so as to account for geographic region or locality specific factors. In this way, the object model for a class of detected object (e.g., bicycle, person, vehicle) can better anticipate the tendencies of such objects, as well as determine alternative inferences when such objects are detected. Thus, for example, two autonomous vehicles 410 in different geographic regions can respond to a similar object (e.g., bicycle), encountered under similar context (e.g., same pose and position relative to roadway), in very different manners (e.g., hard brake and swerve in lane versus ignore or slow down slightly).

By way of example, the object model can determine the response of the vehicle 410 based on the contextual information of the bicyclist, as well as geographic-specific considerations (e.g., whether bicycle messengers are likely present in the geographic region or locality of the vehicle 410). Thus, the vehicle 410 can respond to the bicycle 402 by, for example, (i) anticipating no collision if the bicycle is detected to be relatively stationary or slow moving; (ii) anticipating a moderate risk of collision if the bicyclist is detected as moving at reasonable speed into the road way when the object model in use anticipates few bicyclist and no messenger bicycles, or (iii) anticipating a low risk of collision if the bicyclist is detected as moving at reasonable speed into the road way when the object model in use anticipates bicyclist and messenger bicycles. The geographic region or locality can weight or otherwise influence aspects of models, such as parameters that reflect significance of presence of the object near the path of the vehicle (e.g., how likely is it for an object of the detected class to be present), position, pose, speed and direction of movement.

With respect to the pedestrian 404, the object model can determine (i) likelihood that the pedestrian will cross the road way without use of cross-walk 415, (ii) likelihood that pedestrian will force right of way and enter crosswalk when traffic is moving, and (iii) likelihood that pedestrian will walk outside of the boundary of the crosswalk. The object model can factor information such as provided by the pose of the pedestrian, and/or the position of the pedestrian. The vehicle 410 can also process contextual information that is more granular, such as the orientation or direction of the eyes of the pedestrian. Still further, the contextual information can include surrounding information, such as whether other pedestrians are near, the color of the traffic signal, whether oncoming traffic is present.

With respect to the opposing vehicle 406, the control system 100 can operate to determine whether the vehicle crosses a divider, or whether the vehicle speed allots time for the vehicle to perform an avoidance action if needed. The vehicle 410 can utilize surrounding contextual information, such as whether parked cars exist which could open doors or otherwise cause sudden evasive action on the part of the driver of the vehicle 406.

According to examples, the control system 100 of the vehicle 410 determines an interference score, which can correlate to the type of object and/or the probability that the object will interfere or collide with the vehicle 410 along a current path of motion. As described with some other examples, the interference score can also identify the region of collision, as well as the severity or damage from the collision and other facets. Based on the interference score, the control system 100 of the vehicle 410 can select to perform an avoidance action. The avoidance actions can include velocity adjustments, lane aversion, road way aversion (e.g., change lanes or driver far from curb), light or horn actions, and other actions. As described with an example of FIG. 2, the avoidance action can include those which break driving convention or rules (e.g., allow vehicle 410 to drive across center line to create space with bicyclist).

Hardware Diagrams

FIG. 5 is a block diagram that illustrates a control system for an autonomous vehicle upon which embodiments described herein may be implemented. An autonomous vehicle control system 500 can be implemented using a set of processors 504, memory resources 506, multiple sensors interfaces 522, 528 (or interfaces for sensors) and location-aware hardware such as shown by GPS 524.

According to some examples, the control system 500 may be implemented within an autonomous vehicle with software and hardware resources such as described with examples of FIG. 1-3. In an example shown, the control system 500 can be distributed spatially into various regions of a vehicle. For example, a processor bank 504 with accompanying memory resources 506 can be provided in a vehicle trunk. The various processing resources of the control system 500 can also include distributed sensor processing components 534, which can be implemented using microprocessors or integrated circuits. In some examples, the distributed sensor logic 534 can be implemented using field-programmable gate arrays (FPGA).

In an example of FIG. 5, the control system 500 further includes multiple communication interfaces, including one or more multiple real-time communication interface 518 and asynchronous communication interface 538. The various communication interfaces 518, 538 can send and receive communications to other vehicles, central services, human assistance operators, or other remote entities for a variety of purposes. In the context of FIG. 1 and FIG. 2, control system 100 can be implemented using the autonomous vehicle control system 500, such as shown with an example of FIG. 5. In one implementation, the real-time communication interface 518 can be optimized to communicate information instantly, in real-time to remote entities (e.g., human assistance operators). Accordingly, the real-time communication interface 518 can include hardware to enable multiple communication links, as well as logic to enable priority selection.

The vehicle control system 500 can also include a local communication interface 526 (or series of local links) to vehicle interfaces and other resources of the vehicle 10. In one implementation, the local communication interface 526 provides a data bus or other local link to electro-mechanical interfaces of the vehicle, such as used to operate steering, acceleration and braking, as well as to data resources of the vehicle (e.g., vehicle processor, OBD memory, etc.).

The memory resources 506 can include, for example, main memory, a read-only memory (ROM), storage device, and cache resources. The main memory of memory resources 506 can include random access memory (RAM) or other dynamic storage device, for storing information and instructions which are executable by the processors 504.

The processors 504 can execute instructions for processing information stored with the main memory of the memory resources 506. The main memory can also store temporary variables or other intermediate information which can be used during execution of instructions by one or more of the processors 504. The memory resources 506 can also include ROM or other static storage device for storing static information and instructions for one or more of the processors 504. The memory resources 506 can also include other forms of memory devices and components, such as a magnetic disk or optical disk, for purpose of storing information and instructions for use by one or more of the processors 504.

One or more of the communication interfaces 518 can enable the autonomous vehicle to communicate with one or more networks (e.g., cellular network) through use of a network link 519, which can be wireless or wired. The control system 500 can establish and use multiple network links 519 at the same time. Using the network link 519, the control system 500 can communicate with one or more remote entities, such as network services or human operators. According to some examples, the control system 500 stores vehicle control instructions 505, which include prediction engine instructions 515. During runtime (e.g., when the vehicle is operational), one or more of the processors 504 execute the vehicle control instructions 505, including the prediction engine instructions 515, in order to implement functionality such as described with the control system 100 (see FIGS. 1 and 2) of the autonomous vehicle 10.

In operating the autonomous vehicle 10, the one or more processors 504 can access data from a road network 525 in order to determine a route, immediate path forward, and information about a road segment that is to be traversed by the vehicle. The road network can be stored in the memory 506 of the vehicle and/or received responsively from an external source using one of the communication interfaces 518, 538. For example, the memory 506 can store a database of roadway information for future use, and the asynchronous communication interface 538 can repeatedly receive data to update the database (e.g., after another vehicle does a run through a road segment).

According to some examples, one or more of the processors 504 execute the vehicle control instructions 505 to process sensor data 521 obtained from the sensor interfaces 522, 528 for a road segment on which the autonomous vehicle is being driven. In executing the predictive engine instructions 515, the one or more processors 504 analyze the sensor data 521 to determine an interference value 527 for individual points of an upcoming road segment. As described with other examples, the interference value 527 can indicate a probability that at least a particular class of dynamic object will interfere with a selected path of the autonomous vehicle at one or more points of the road segment. The one or more processors 504 can then execute the vehicle control instructions 505 to adjust operation of the autonomous vehicle based on the determined interference value 527. In an example of FIG. 5, the operations of the autonomous vehicle 10 can be adjusted when one of the processors 504 signals commands 535 through local communication links to one or more vehicle interfaces of the vehicle.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is being claimed is:

1. A control system for an autonomous vehicle, the control system comprising:
a memory to store an instruction set;
one or more processors to execute instructions from the instruction set to:
process sensor data obtained for a road segment on which the autonomous vehicle is being driven;
determine, from processing the sensor data, an interference value for individual points of the road segment, the interference value indicating a probability that at least a particular class of dynamic object will interfere with a selected path of the autonomous vehicle at one or more points of the road segment; and
adjust operation of the autonomous vehicle based on the determined interference value.

2. The control system of claim 1, wherein the one or more processors execute instructions to determine an interference value using logic that is specific to a geographic region of the road segment.

3. The control system of claim 2, wherein the one or more processors execute instructions to implement a model for anticipating a behavior of one or more classes of dynamic objects based on the geographic region of the road segment.

4. The control system of claim 3, wherein the model is weighted based on parametric values that are specific to the geographic region of the road segment.

5. The control system of claim 1, wherein the one or more processors determine the interference value to indicate the probability that an object from any of multiple classes of dynamic objects will interfere with the selected path of the autonomous vehicle.

6. The control system of claim 5, wherein the multiple classes of dynamic objects include pedestrians, bicycles, and other vehicles.

7. The control system of claim 1, wherein the one or more processors determine the interference value to indicate that probability that at least a class of unseen objects will interfere with a selected path of the autonomous vehicle at one or more points of the road segment.

8. The control system of claim 7, wherein the one or more processors determine the interference value for the unseen object in response to determining a point of ingress that is occluded from the set of sensors of the autonomous vehicle.

9. The control system of claim 1, wherein the one or more processors determine the interference value for a seen object of the particular class when the object is not on a path to collide or interfere with the autonomous vehicle.

10. The control system of claim 1, wherein the one or more processors adjust the operation of the vehicle by adjusting a velocity of the autonomous vehicle in response to determining that the interference value exceeds a particular threshold.

11. The control system of claim 1, wherein the sensor data includes image data, and wherein the one or more processors determine the interference value by performing image analysis on the image data to detect and classify a dynamic object in the road segment.

12. The control system of claim 11, wherein the one or more processors perform image analysis to detect contextual information for a detected dynamic object of a particular class.

13. The control system of claim 12, wherein the contextual information includes information to determine a position and a pose of the dynamic object at a current instance.

14. The control system of claim 12, wherein the contextual information includes information that identifies an attribute of a motion of the dynamic object relative to a point of the road segment.

15. The control system of claim 11, wherein the one or more processors perform image analysis to detect contextual information for at least a portion of the road segment, wherein detecting the contextual information of the road segment is based at least in part on identifying static objects that are known to have previously existed on the road segment.

16. The control system of claim 1, wherein the one or more processors adjust the operation of the vehicle by controlling the autonomous vehicle to deviate from a driving constraint in response to determining that the interference value exceeds a particular threshold.

17. The control system of claim 16, wherein the one or more processors control the autonomous vehicle in deviating from the driving constraint by maintaining the autonomous vehicle within a defined lane of the road segment.

18. The control system of claim 16, wherein the one or more processors control the autonomous vehicle in deviating from the driving constraint by changing a right-of-way process by which the autonomous vehicle passes through an intersection.

19. A method for operating an autonomous vehicle, the method being implemented by one or more processors and comprising:
processing sensor data obtained for a road segment on which the autonomous vehicle is being driven;
determining, from processing the sensor data, an interference value for individual points of the road segment, the interference value indicating a probability that at least a particular class of dynamic object will interfere with a selected path of the autonomous vehicle at one or more points of the road segment; and
adjusting operation of the autonomous vehicle based on the determined interference value

20. An autonomous vehicle comprising:
a control system comprising:
a memory to store an instruction set;
one or more processors to execute instructions from the instruction set to:
process sensor data obtained for a road segment on which the autonomous vehicle is being driven;
determine, from processing the sensor data, an interference value for individual points of the road segment, the interference value indicating a probability that at least a particular class of dynamic object will interfere with a selected path of the autonomous vehicle at one or more points of the road segment; and
adjust operation of the autonomous vehicle based on the determined interference value.
